(19) United States
(12) Patent Application Publication
(10) Pub. No.: US 2008/0230306 A1
(43) Pub. Date: Sep. 25, 2008

(54) MUFFLE CHAMBER DUCT

(75) Inventor: Takayuki ICHIKAWA, Hamamatsu-shi (JP)

Correspondence Address: Young & Thompson, 209 Madison Street, Suite 500, Alexandria, VA, 22314, US

(73) Assignee: TOYO ROKI SEIZO KABUSHIKI KAISHA, Hamamatsu-shi, Shizuoka (JP)

(21) Appl. No.: 12/050,222

(22) Filed: Mar. 18, 2008

(30) Foreign Application Priority Data
Mar. 19, 2007 (JP) 2007-070402

(51) Int. Cl. F02M 35/00

(52) U.S. Cl. 181/229

(57) ABSTRACT

A pipe is incorporated in an intake system and having a first hole for a noise in the intake system to be released therethrough. A cover covers the pipe for attenuating the noise, having a second hole.

### CROSS-REFERENCE TO RELATED APPLICATIONS

This application is based upon and claims the benefit of priority from Japanese Patent Application No. 2007-070402 filed on Mar. 19, 2007; the entire contents of which are incorporated herein by reference.

### BACKGROUND OF THE INVENTION

The invention relates to a muffle chamber duct applicable for an intake system of, for example, an internal combustion, an air conditioner or an air compressor.

A general intake duct causes a noise when allowing air to be taken or be discharged therethrough.

A related intake duct includes an intake portion, a resin duct portion, and a fiber duct portion connecting the intake portion and the resin duct potion. The fiber duct portion includes a woven fabric having ventilablity (Refer to Patent Document 1).

Another intake duct includes a cylindrical inner frame connected between a first duct and a second duct, an outer cylinder covering the inner frame, a sound absorption material adhered to the inner circumferential surface of the outer cylinder, and an end wall member filled between the ends of the inner frame and the outer cylinder (Refer to Patent Document 2).

Patent Document 1: Japanese Patent Application Laid-open No. 2003-343373

Patent Document 2: Japanese Patent Application Laid-open No. 2004-346750

The intake duct of Patent Document 1 produces a great effect of reducing intake noise of a middle frequency range. This intake duct, however, produces a small effect of reducing intake noise of a high frequency range.

The intake duct of Patent Document 2 produces a great effect of reducing intake noise of a high frequency range. This intake duct, however, produces a small effect of reducing intake noise of a middle frequency range. The intake duct produces little effect of reducing intake noise of a low frequency range.

### SUMMARY OF THE INVENTION

The invention is directed to a muffle chamber duct enhancing an effect of reducing noise of a middle frequency range, keeping an effect of reducing noise of a high frequency range.

The first aspect of the invention provides the following muffle chamber duct. The duct includes a pipe incorporated in an intake system and having a first hole for a noise in the intake system to be released therethrough. The duct includes a cover covering the pipe for attenuating the noise, having a second hole.

The first hole and the second hole may be off from each other circumferentially of the pipe.

The first hole and the second hole may open radially of the pipe, respectively.

The first hole may open radially of the pipe. The second hole may open circumferentially of the pipe.

The first hole may open vertically of the pipe. The second hole may open horizontally of the pipe.

The pipe may include a sound absorption material.

### BRIEF DESCRIPTION OF THE ACCOMPANYING DRAWINGS

FIG. 1 is a schematic view of an intake system in which a muffle chamber duct according to a first embodiment of the invention is applied;

FIG. 2 is a plan view of the muffle chamber duct as illustrated in FIG. 1;

FIG. 3A is an exploded perspective view of the muffle chamber duct;

FIG. 3B is an enlarged perspective view of the outer pipe;

FIG. 3C is a sectional view of the chamber duct;

FIGS. 4A and 4B are graphs showing muffle effects in comparison of an example and a comparative example 1;

FIGS. 4C and 4D are graphs showing muffle effects in comparison of an example and a comparative example 2;

FIG. 5A is a perspective view of a muffle chamber duct according to a second embodiment of the invention;

FIG. 5B is a sectional view of the muffle chamber duct; and

FIG. 5C is a sectional view of a muffle chamber duct according to a modified embodiment.

### DETAILED DESCRIPTION OF THE EMBODIMENTS

Embodiments of the invention will be described below with reference to the accompanying drawings.

### First Embodiment

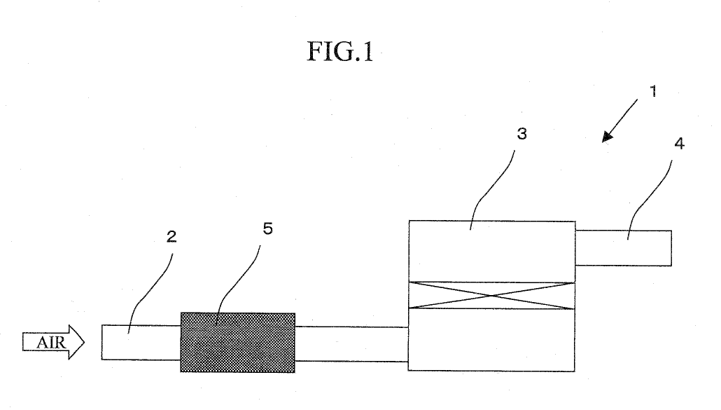

With reference to FIG. 1, an intake system 1 includes an intake duct 2 for air intake, an air cleaner 3 connected to the intake duct 2, an air flow tube 4 connected to the air cleaner 3 and placed on the engine side, and a muffle chamber duct 5 incorporated in the intake duct 2.

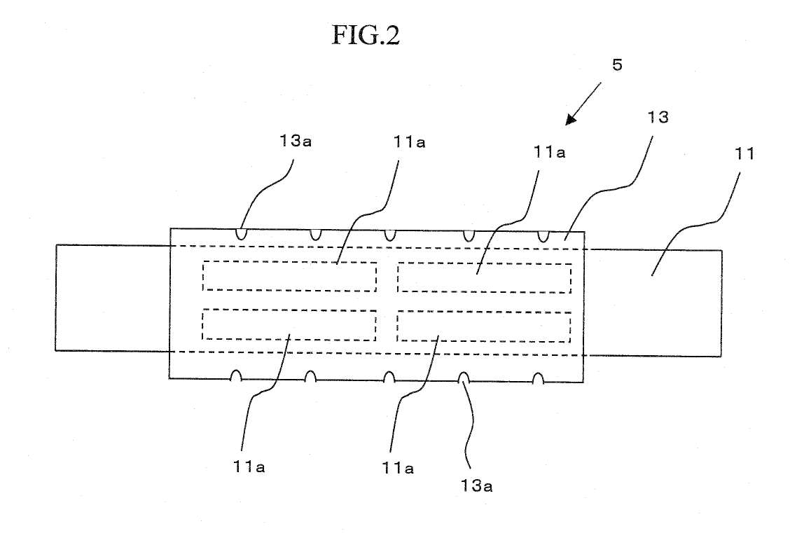

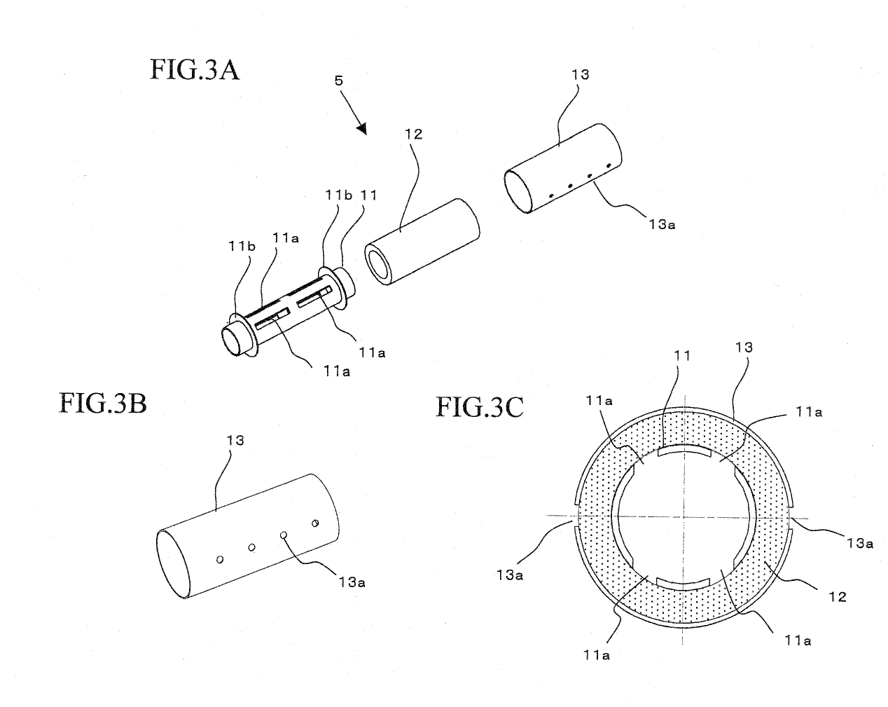

With reference to FIGS. 2 and 3A, the muffle chamber duct 5 includes an inner pipe 11 connected to the intake duct 2, a sound absorption material 12 enclosing the inner pipe 11, and an outer pipe 13 as a cover enclosing the sound absorption material 12.

With reference to FIGS. 3A, 3B and 3C, the cylindrical inner pipe 11 has a pair of flanges lib at both the ends in the direction of the cylindrical axis (referred to as an axial direction). The inner pipe 11 is placed between the flanges 11b, with elongated holes 11 extending in the axial direction. The elongated holes 11 are arranged circumferentially in two rows, and are positioned clockwise at 30, 120, 150, 210, and 330 degrees, respectively (refer to FIG. 3C). These elongated holes 11a allow a noise in the intake duct 2 to be released therethrough, preventing resonance in the intake duct 2.

The cylindrical sound absorption material 12 is held between the flanges 11b, covering the elongated holes 11a. The sound absorption material 12 employs, for example, a polyurethane foam having continuous foams, a polyethylene foam, a melanine resin foam, a nonwoven fabric, or a fiber element.

The cylindrical outer pipe 13 is placed between the flanges 11b of the inner pipe 11. The outer pipe 13 has relief holes 13a each as a second hole arranged in the axial direction (refer to FIG. 3B). These relief holes 13a are provided clockwise, for example, at the positions 90 and 270 degrees. That is, the relief holes 13a are positioned off from elongated holes 11a in the circumference direction of the pipe 11. The relief holes 13a are positioned off from the elongated holes 11a at predetermined angles, without coinciding with the elongated holes 11a. These relief holes 13a open to the wall of the inner pipe 11. The relief holes 13a open in radial directions of the inner pipe 11 as well as the elongated holes 11a.

Next, a method of operating the intake system 1 is described.

With reference to FIG. 1, for example, when an engine starts, the intake valve allows an air to be taken therethrough. The air flows into the intake duct 2 to pass through the air cleaner 3, being taken from the air flow tube 4 into the engine side. The air produces a pulsation in the intake valve, causing an intake noise. The intake noise transmits via the reverse path to the above path to radiate from the intake.

Then, referring to FIG. 2, the inner pipe 11 allows the intake noise to be released from the elongated holes 11a into the outer pipe 13. The sound absorption material 12 absorbs an intake noise of a high frequency range of 1000 Hz or more from the released intake sound. The relief holes 13a of the outer pipe 13 allow an intake noise of a middle frequency range from 200 Hz to 400 Hz to be released outside, preventing resonance in the chamber duct 5, thus reducing the intake noise of the middle frequency range. Herein, the relief holes 13a are positioned circumferentially off from the elongated holes 11a, opening to the wall of the inner pipe 11. This structure prevents a large leakage of an intake noise of a low frequency range of 150 Hz or less.

According to the above muffle chamber duct 5, the relief holes 13a reduces a noise of a middle frequency range, keeping an effect on reduction of noise of a high frequency range.

The relief holes 13a are positioned so as not to coincide with the elongated holes 11a in the circumference direction of the pipe 11, preventing a large leakage of a noise of a low frequency range.

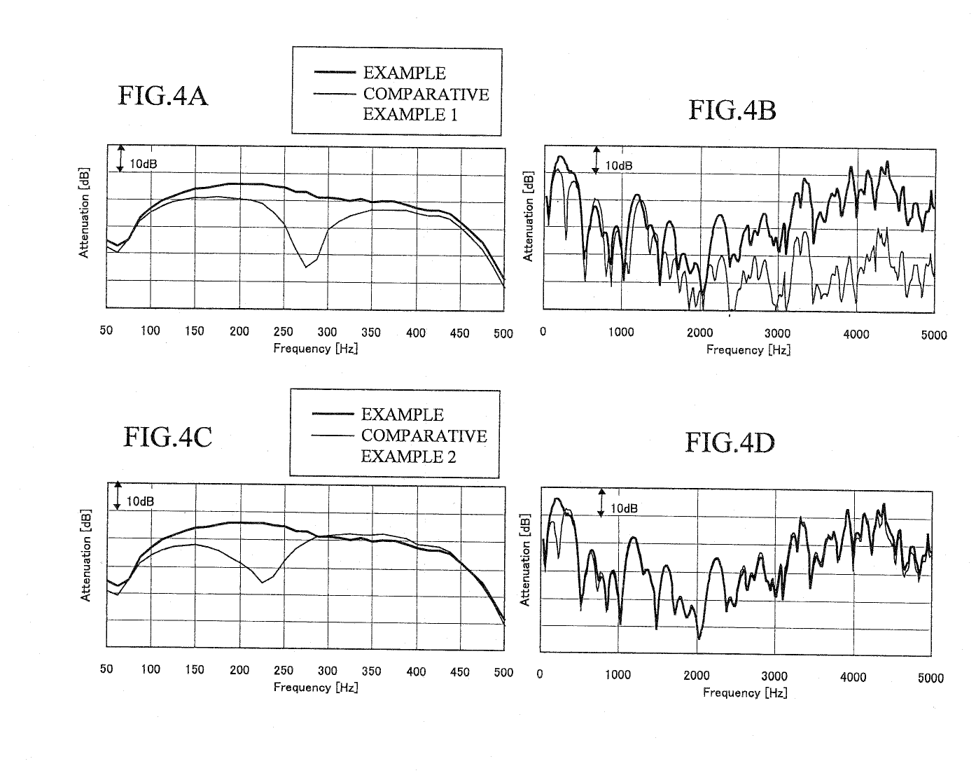

Next, referring to FIGS. 4A and 4B, the experimental result of the muffle chamber duct 1 is described.

The graphs as shown in FIGS. 4A and 4B show results from the comparison between the example and the comparative example 1. The example includes the muffle chamber duct of the embodiment. The comparative example 1 is a duct without any mufflers. The horizontal axis indicates frequency of intake noise. The vertical axis indicates attenuation of intake noise of predetermined frequencies.

The example shows a great attenuation at around 40 dB at the maximum for noises of a high frequency range from 2000 Hz to 5000 Hz and a middle frequency range from 200 Hz to 400 Hz.

The example shows an attenuation substantially equal to that of the comparative example 1 for an intake noise of a low frequency range of 150 Hz or less.

The graphs as illustrated in FIGS. 4C and 4D show results from the comparison between the example and a comparative example 2. The comparative example 2 includes a muffle chamber duct similar to that of the embodiment, with a structure having an outer pipe without any holes.

The example and the comparative example 2 show equal attenuations for an intake noise of a high frequency range from 2000 Hz to 5000 Hz. The example shows an attenuation for an intake noise of a middle frequency noise from 150 Hz to 280 Hz greater than that of the comparative example 2 by around 20 dB at the maximum. The example shows an attenuation for an intake noise of a low frequency range of 150 Hz or less slightly greater than that of the comparative example 2 by around 5 dB at the maximum.

According to the above description, it is shown that the example greatly attenuates intake noises of high and middle frequency ranges and substantially maintains an intake noise of a middle frequency range.

### Second Embodiment

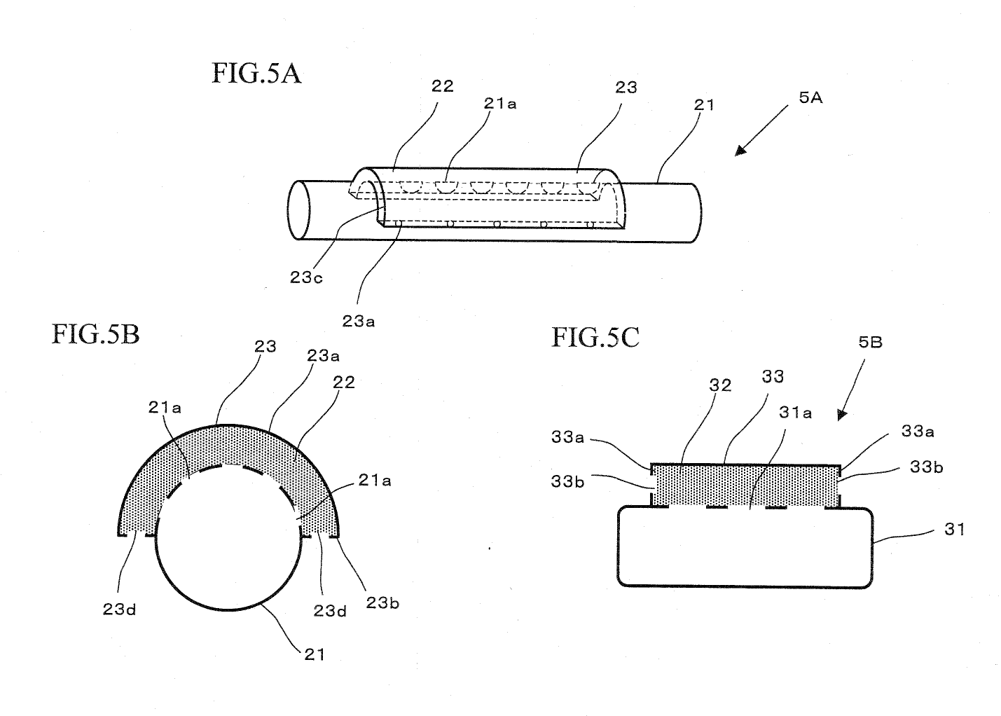

With reference to FIGS. 5A and 5B, a muffle chamber duct 5A includes an inner pipe 21 as a pipe, a sound absorption material 22 placed on the inner pipe 21, an outer cover 23 as a cover placed on the circumference of the sound absorption material 22.

The inner pipe 21 has holes 21a each as a first hole arranged on the upper half circumferential surface at predetermined angular intervals (refer to FIG. 5B. FIG. 5A illustrates holes as representatives on the top portion). These holes 21a are arranged at predetermined intervals in the axial direction.

The sound absorption material 22 is half cylindrical and covers the holes 21a of the inner pipe 21.

The outer cover 23 includes a half cylindrical base wall 23a extending in the circumferential direction and covering the outer surface of the sound absorption material 22. The outer cover 23 includes circumferential end walls 23b extending radially inward from the circumferential ends of the base wall 23a and covers the circumferential end surfaces of the sound absorption material 22. The outer cover 23 includes axial end walls 23c extending radially inward from the axial ends of the base wall 23a and covers the axial end surfaces of the sound absorption material 22.

The circumferential end walls 23b have relief holes 23d each as a second hole arranged in the axial direction. These relief holes 23d are positioned off from the holes 23a in the circumferential direction. The relief holes 23d open in the circumferential direction of the inner pipe 21, while the elongated holes 21a open in the radial direction. Thus, the relief holes 23d provide the muffle chamber duct 5A with an advantage equal to that of the first embodiment.

With reference to FIG. 5C, the muffle chamber duct 5B according to the modified embodiment includes an inner pipe 31 of a rectangular section as a pipe. The inner pipe 31 has an upper wall defining holes 31a each as a first hole. The duct 5B includes a sound absorption material 32 of a rectangular section located on the upper wall of the inner pipe 31 for covering the holes 31a. The duct 5B includes an outer cover 33 as a cover arranged on the circumference of the sound absorption material 32.

This outer cover 33 has side walls 33a opposed to each other in the horizontal direction. Both side walls 33a have relief walls 33b each as a second hole positioned off from the holes 31a in the sectionally horizontal direction. The relief holes 33b open in the horizontal direction of the inner pipe 31, while the holes 31a open in the vertical direction of the inner pipe 31. These relief holes 33b also provide the muffle chamber duct 5B with an advantage equal to that of the first embodiment.

Although the invention has been described above by reference to certain embodiments of the invention, the invention is not limited to the embodiments described above. Modifications and variations of the embodiments described above will occur to those skilled in the art, in light of the above teachings. The scope of the invention is defined with reference to the following claims.

According to the aspect of the invention, the second hole reduces a noise of a middle frequency range, keeping an effect of reducing a noise of a high frequency range.

The second hole does not coincide with the first hole, thus preventing a large leakage of a noise of a low frequency range.

What is claimed is:

1. A muffle chamber duct comprising:
a pipe incorporated in an intake system and having a first hole for a noise in the intake system to be released therethrough; and
a cover covering the pipe for attenuating the noise, having a second hole.

2. The muffle chamber duct according to claim 1,
wherein the first hole and the second hole are positioned off from each other circumferentially of the pipe.

3. The muffle chamber duct according to claim 2,
wherein the first hole and the second hole open radially of the pipe, respectively.

4. The muffle chamber duct according to claim 2,
wherein the first hole opens radially of the pipe, and
wherein the second hole opens circumferentially of the pipe.

5. The muffle chamber duct according to claim 2,
wherein the first hole opens vertically of the pipe, and
wherein the second hole opens horizontally of the pipe.

6. The muffle chamber duct according to claim 1,
wherein the pipe includes a sound absorption material.
